(19) United States
(12) Patent Application Publication
(10) Pub. No.: US 2026/0356710 A1
(43) Pub. Date: Nov. 12, 2026

(54) ACID DOSING PREDICTION AND ADJUSTMENT BASED ON PH MEASUREMENTS

(71) Applicant: ZODIAC POOL SYSTEMS LLC, Carlsbad, CA (US)

(72) Inventor: Anthony Levacque, Newnan, GA (US)

(73) Assignee: ZODIAC POOL SYSTEMS LLC, Carlsbad, CA (US)

(21) Appl. No.: 19/666,629

(22) Filed: May 4, 2026

Related U.S. Application Data
(60) Provisional application No. 63/801,738, filed on May 7, 2025.

(51) Int. Cl. C02F 1/66; C02F 103/42

(52) U.S. Cl. CPC C02F 1/66; C02F 2103/42; C02F 2209/003; C02F 2209/006; C02F 2209/06

(57) ABSTRACT

A system for monitoring water quality of a swimming pool or spa includes an acid dosing system and a control system. The control system may obtain one or more pH measurements of water of a swimming pool or spa from a water sensing device as a first pH parameter. The control system may also obtain additional information relevant to the pH of the water as a second pH parameter as a second pH parameter. In certain cases, the control system may determine an amount of acid and/or a volume of acid based on the first pH parameter and the second pH parameter. The control system may further generate a control response for the automatic acid dosing system of the swimming pool or spa based on the determined amount of acid and/or the determined volume of acid.

### REFERENCE TO RELATED APPLICATION

This application claims the benefit of and priority to U.S. Provisional Patent Application No. 63/801,738, filed on May 7, 2025, and entitled ACID DOSING PREDICTION AND ADJUSTMENT BASED ON PH MEASUREMENTS, the content of which is hereby incorporated by reference in its entirety.

### FIELD OF THE INVENTION

The invention relates to water testing or monitoring systems, and more particularly, but not necessarily exclusively, to water testing or monitoring systems for swimming pools or spas.

### BACKGROUND

Maintaining water quality is important for swimming pools, spas, hot tubs, and other water containing vessels (hereinafter “swimming pools or spas”) to avoid issues for users of the pool as well as equipment of the pool. For example, if the water chemistry of the swimming pool or spa is off, a health hazard may be posed to users and/or operation of various pool equipment and/or systems may be compromised.

Some conventional approaches to monitoring water parameters include reagent-based sensing using chemistry kits, remote testing, maintenance service calls, and probes or sensors. Conventional chemistry kits may be complicated and not user-friendly to pool owners, and the individual using the chemistry may be uncertain of the results. Remote testing requires the taking of a sample of water to a store or chemistry laboratory to analyze and may pose issues of sample contamination, improper storage, and/or a change in water chemistry during transit. Reagent-based approaches are typically only performed periodically by a customer due to the volume of reagent required, and the periodic approach may lead to safety issues (e.g., the water may become very acidic or overchlorinated). Sensors or probes are generally expensive and occupy space on the pool pad, and sensors have a limited lifetime and require calibration and maintenance over time (eventually requiring replacement).

Regardless of the technique used to obtain the water parameter measurement, this information alone is not enough to safely address the issue. As an example, the measurement of pH only indicates the pH of the pool water at a specific time, and provides no information for safely dosing liquid acid into the pool to correct the pH. As such, acid is commonly added to the pool manually once a week by a pool professional and/or the setting of a dosing cycle is determined manually by the pool professional and/or end user. However, such techniques are not efficient and may lead to significant variations of the pH, potentially leading to over-dosing acid into the pool or under-dosing acid into the pool, both of which may pose significant risk to the equipment, the swimmers, and the pool. As such, many existing approaches to monitoring water quality may be inaccurate, labor-intensive, and time-consuming.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a water quality monitoring system includes a control system configured to obtain a first pH parameter and a second pH parameter, wherein the first pH parameter is a pH measurement of water of a swimming pool or spa from a water sensing device, and wherein the second pH parameter comprises additional information relevant to the pH of the water, and generate a control response for an automatic acid dosing system of the swimming pool or spa based on an assessment of the pH measurements with the additional information.

According to some embodiments, a water quality monitoring system includes a control system configured to obtain a first pH parameter and a second pH parameter, wherein the first pH parameter is a pH measurement of water of a swimming pool or spa from a water sensing device and the second pH parameter is an alkalinity of the water. The control system may determine an amount and/or volume of acid based on the pH and the alkalinity, and may generate a control response for an automatic acid dosing system of the swimming pool or spa based on the determined amount and/or volume.

In some embodiments, a water quality monitoring system is configured to vary acid dosing based on two pH parameters.

According to some embodiments, a non-transitory computer readable storage medium includes a plurality of instructions executable by one or more processors, the plurality of instructions comprising instructions which, when executed by the one or more data processors, cause the one or more data processors to perform actions including: obtaining a first pH parameter and a second pH parameter, wherein the first pH parameter is one or more pH measurements of water of a swimming pool or spa from a water sensing device, and wherein the second pH parameter comprises additional information relevant to the pH of the water; and generating a control response for an automatic acid dosing system of the swimming pool or spa based on an assessment of the pH measurements with the additional information.

In various embodiments, a non-transitory computer readable storage medium includes a plurality of instructions executable by one or more processors, the plurality of instructions comprising instructions which, when executed by the one or more data processors, cause the one or more data processors to perform actions including: obtaining pH measurements of water of a swimming pool or spa from a water sensing device; obtaining alkalinity of the water; determining an amount and/or volume of acid based on the pH and the alkalinity; and generating a control response for an automatic acid dosing system of the swimming pool or spa based on the determined amount and/or volume.

According to certain embodiments, a method of monitoring a water parameter of a swimming pool or spa includes obtaining a first pH parameter and a second pH parameter, wherein the first pH parameter is one or more pH measurements of water of a swimming pool or spa from a water sensing device, and wherein the second pH parameter includes additional information relevant to the pH of the water. The method includes generating a control response for an automatic acid dosing system of the swimming pool or spa based on an assessment of the pH measurements with the additional information.

According to some embodiments, a method of monitoring a water parameter of a swimming pool or spa includes obtaining pH measurements of water of a swimming pool or spa from a water sensing device, obtaining alkalinity of the water, determining an amount and/or volume of acid based on the pH and the alkalinity, and generating a control response for an automatic acid dosing system of the swimming pool or spa based on the determined amount and/or volume.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system according to embodiments.

FIG. 2 illustrates a method of controlling the pool system of FIG. 1 according to embodiments.

### DETAILED DESCRIPTION

Described herein are systems and methods for automatically predicting and/or adjusting automatic acid dosing cycles for a swimming pool or spa based on two (or more) pH parameters. In certain embodiments, the first pH parameter is an automatic pH measurement and the second pH parameter includes additional information. In certain embodiments, the automatic pH measurement may be obtained automatically by various techniques as desired, such as but not limited to automated reagent-based techniques and/or sensor-based techniques.

The additional information may be various information relevant to the pH of water of the swimming pool or spa. As non-limiting examples, the additional information may include, but is not limited to, an alkalinity of the water, a volume of the swimming pool or spa, a pool or spa mode configuration, a presence and/or type of equipment impacting the pH (e.g., overflow, fountains, jets, etc.), a pump filtration schedule, a water temperature, a historical acid dosing cycle parameter (e.g., volume, duration, etc.), combinations thereof, and/or other additional information as desired.

The additional available information may be obtained automatically by the system or manually as desired. As non-limiting examples, the additional available information may be obtained automatically from one or more sensors, connected devices, connected services, combinations thereof, and/or as otherwise desired. Additionally, or alternatively, the additional available information may be obtained (or received) manually directly from a user and/or a user may manually provide information into an application running on a user device, and the user device may be communicatively coupled with the system.

In various embodiments, predicting and/or adjusting an acid dosing cycle based on a pH measurement and additional information may facilitate the safe dosing of acid (e.g., muriatic acid) into the swimming pool or spa to control the pH. The systems and methods described herein may minimize and/or reduce over-dosing and/or under-dosing of acid into the swimming pool or spa, thereby minimizing adverse impacts on equipment, swimmers, and the pool from over-dosing and/or under-dosing. The systems and methods described herein may also provide improved control over pH dosing by predicting and/or adjusting the dosing cycle based on additional information relevant to the pH. Such additional information may allow the system to account for actual usage of the swimming pool or spa to determine a dosing cycle for providing the water with a desired pH. Various other benefits and advantages may be realized with the systems, devices, and methods provided herein, and the aforementioned advantages should not be considered limiting.

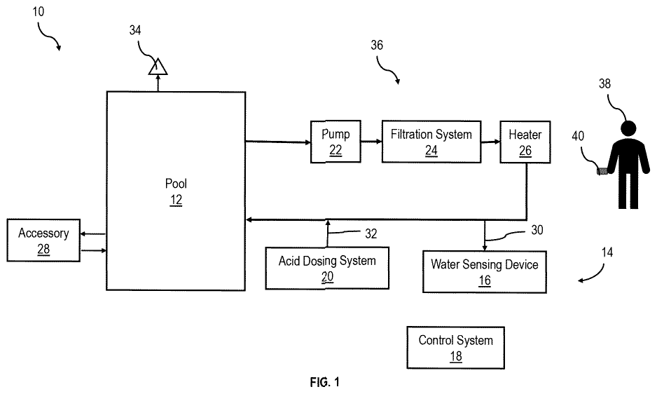

FIG. 1 illustrates an example of a pool system 10 according to embodiments. The pool system 10 generally includes a pool or spa 12 (hereinafter “pool 12”) and a monitoring system 14 for monitoring and/or controlling a pH of water of the pool 12.

The pool 12 may have various features, arrangements, shapes, and profiles as desired, and the particular pool 12 illustrated should not be considered limiting. In some embodiments, the pool 12 includes a circulation system 36 for circulating water and/or performing various actions for controlling the water quality of the water of the pool 12. In certain embodiments, the circulation system 36 includes one or more pumps 22, a filtration system 24, and optionally a heater 26. Optionally, the pool 12 may include various accessory devices or features 28 for entertainment or other purposes. Non-limiting examples of such accessory devices or features 28 may include but are not limited to overflows, waterfalls, fountains, jets, combinations thereof, and/or other devices or features desired.

Optionally, the pool system 10 may include one or more sensors 34 for detecting and/or measuring various information about the pool. Such sensors 34 may include, but are not limited to, a water temperature sensor, a water parameter sensor measuring one or more water parameters such as but not limited to ORP, free chlorine, total chlorine, total alkalinity, and/or cyanuric acid concentration, a camera configured to detect a number of swimmers and/or debris within the pool 12, combinations thereof, and/or other sensors 34 as desired.

In certain embodiments, various aspects of the pool 12 itself and/or equipment or features associated with the pool 12 may at least partially impact the pH of the water of the pool 12 and may be considered a pH parameter. As non-limiting examples and as discussed in detail below, a volume of the pool 12, a temperature of the water of the pool 12, certain accessory features 28 (e.g., overflow, fountains, jets, etc.), a filtration schedule, a heating mode, combinations thereof, and/or other aspects of the pool 12 and/or associated equipment may at least partially impact the pH of the water of the pool 12. As previously discussed, traditional techniques for controlling the pH of the water of the pool 12 require manual addition of acid to the pool and/or a manual determination of a dosing cycle, but such techniques may lead to significant variations of the pH, potentially leading to over-dosing acid into the pool or under-dosing acid into the pool.

The monitoring system 14 described herein overcomes the limitations of traditional approaches and provides a system which not only obtains pH information but automatically predicts and/or adjusts an automatic acid dosing cycle. As illustrated in FIG. 1, the monitoring system 14 generally includes one or more water sensing devices 16, a control system 18, and an acid dosing system 20.

The water sensing device 16 may be various suitable devices for automatically measuring and/or detecting at least the pH of the water of the pool 12 (represented by arrow 30). Optionally, the water sensing device 16 may detect one or more other water parameters. As non-limiting examples and as discussed in detail below, water sensing device 16 optionally may measure water parameters such as but not limited to ORP, free chlorine, total chlorine, total alkalinity, and/or cyanuric acid concentration. While a single water sensing device 16 is illustrated in FIG. 1, in other embodiments, the monitoring system 14 may include any number of water sensing devices 16 as desired, including a plurality of water sensing devices 16. In embodiments with a plurality of water sensing devices 16, at least one of the water sensing devices 16 is provided for automatically measuring and/or detecting the pH of the water of the pool 12, while other water sensing devices 16 need not necessarily detect the pH of the water. In such embodiments, the water sensing devices 16 detecting water parameters other than the pH optionally may serve as one or more of the sensors 34.

In some embodiments, the water sensing device 16 may be a reagent-based water sensing device. In such embodiments, the water sensing device 16 may be various devices or systems which utilize liquid reagents to measure one or more water parameters including at least pH. In such embodiments, various reagent-based devices may be utilized, and in one non-limiting example, the reagent-based device may be similar to the reagent-based device described in U.S. Provisional Patent Application No. 63/651,719, filed on May 24, 2024, and entitled INLINE WATER MONITORING SYSTEM, the content of which is hereby incorporated by reference in its entirety. In other embodiments, the water sensing device 16 may be additional devices suitable for automatically measuring at least the pH of the water of the pool 12. In certain embodiments, and as discussed in detail below, the water sensing device 16 may be communicatively coupled (e.g., via wired and/or wireless communication) to the control system 18 such that the pH measurements obtained by the water sensing device 16 may be provided to the control system 18.

The water sensing device 16 may be provided at various locations and/or relative to various equipment and/or sub-systems of the pool system 10 as desired for measuring the one or more water parameters. As non-limiting examples, the water sensing device 16 may be provided to measure water parameters in the pool 12 itself, in the circulation system 36, as a component of another system (e.g., the acid dosing system 20), combinations thereof, and/or as otherwise desired.

The acid dosing system 20 of the monitoring system 14 may be various suitable devices and/or systems for automatically adding acid (such as but not limited to muriatic acid) to the water of the pool 12 (represented by arrow 32) for adjusting the pH of the water of the pool 12. In certain embodiments, and as discussed in detail below, the acid dosing system 20 may be controlled pursuant to a dosing cycle, which may include a dosing duration and an acid volume. Similar to the water sensing device 16, the acid dosing system 20 may be provided at various locations within the pool system 10 and/or relative to other components and/or systems of the pool system 10, and the particular location of the acid dosing system 20 should not be considered limiting. Similar to the water sensing device 16, and as discussed in detail below, the acid dosing system 20 may be communicatively coupled to the control system 18 such that the acid dosing parameters may be provided to the acid dosing system 20 from the control system 18.

The control system 18 of the monitoring system 14 may include one or more processing units and/or memory devices and is communicatively coupled to the components of the monitoring system 14. The control system 18 may be local to or remote from the pool system 10 as desired. As non-limiting examples, in some embodiments, the control system 18 (or components thereof) may be remote from the pool system 10 and may be internet-based, in the cloud, etc. Additionally, or alternatively, the control system 18 (or components thereof) may be provided locally within the pool system 10 as a stand-alone device and/or component of another device and/or system. As non-limiting examples, while the control system 18 is illustrated as a standalone device in FIG. 1, in other embodiments, one or more components of the control system 18 may be implemented locally onboard the water sensing device 16, the acid dosing system 20, a component of the circulation system 36 (e.g., pump 22, filtration system 24, and/or heater 26, etc.), an accessory feature 28, combinations thereof, and/or as otherwise desired. In one non-limiting example, a single device may include the water sensing device 16, the control system 18, and the acid dosing system 20. Other configurations of the monitoring system 14 may be implemented as desired.

The one or more processing units of the control system 18 may be any suitable processing device or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices of the control system 18 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory, random access memory, magnetic random access memory, core memory, magnetic disk storage mediums, optical storage mediums, flash memory devices, and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. In some embodiments, the control system 18 may include (and/or may be communicatively connected to) one or more generative models (e.g., machine learning models) stored in the memory and/or accessible from a generative model provider. The generative model may be a third-party large language model (e.g., Residual Networks ResNet, GoogLeNet Inception, etc.) or may be a machine learning model that is local to the control system 18 that has been trained to identify various parameters associated with pH levels and/or acid dosing.

In certain embodiments, the control system 18 optionally includes an associated user interface, including but not limited to a human machine user interface, such that the control system 18 may obtain information from a user and/or provide information to the user via the user interface. When included, the user interface may be on the control system 18 itself or may be at a location remote from the control system 18 such as, but not limited to, another location within the pool system 10.

In various embodiments, the control system 18 may include one or more communication modules such that the control system 18 is communicatively coupled to at least the water sensing device 16 and the acid dosing system 20 and may receive and/or send information to at least the water sensing device 16 and the acid dosing system 20. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In certain embodiments, the control system 18 is communicatively coupled to other components of the pool system 10 such that the control system 18 may send and/or receive information with other components. As non-limiting examples, the control system 18 may be communicatively coupled to the accessory features 28, components of the circulation system 36, a sensor 34, a user device 40 of a user 38, combinations thereof, and/or other devices as desired. In one non-limiting example, the control system 18 may receive and/or send information to the user device 40 via an application running on the user device 40.

In certain embodiments, and as discussed in detail below, the control system 18 may obtain two or more pH parameters, with at least one pH parameter coming from the water sensing device 16. The pH parameters obtained by the control system may include, but are not limited to, a pH measurement, an alkalinity of the water, a volume of the swimming pool or spa, a pool or spa mode configuration, a presence and/or type of equipment impacting the pH (e.g., overflow, fountains, jets, etc.), ORP, free chlorine, total chlorine, total alkalinity, cyanuric acid, a pump filtration schedule, a water temperature, a heating mode, a historical acid dosing cycle parameter (e.g., volume, duration, etc.), combinations thereof, and/or other additional information as desired. In certain embodiments, the control system 18 may obtain pH measurements from the water sensing device 16 as a first pH parameter, and may obtain additional information relevant to the pH as a second pH parameter. In certain embodiments, the control system 18 may determine one or more acid dosing parameters of an acid dosing cycle based on an assessment of the first pH parameter (such as but not limited to the pH measurement) and the second pH parameter (such as but not limited to the additional information). Optionally, the control system 18 may control the acid dosing system 20, cause the acid dosing system 20 to dose acid pursuant to the determined acid dosing cycle, and/or generate various output responses based on the assessment of the first pH parameter and the second pH parameter, such as but not limited to the pH and the additional information.

As mentioned, in some embodiments, the control system 18 optionally includes and/or is in communication with a machine learning model that has been trained to identify various parameters associated with acid dosing based on the pH parameters, such as but not limited to the pH measurements and/or additional information. As non-limiting examples, the machine learning model may be trained to identify a dosing volume, a dosing duration, and/or other parameters of an acid dosing cycle based on the pH measurements and additional information. In some embodiments, the machine learning model may be trained to identify an impact that the additional information has on pH (e.g., an amount, a type, a duration, etc.) and predict a future pH of the water of the pool 12 and/or parameters of an acid dosing cycle based on the predicted future pH. In certain embodiments, the control system 18 with the machine learning model may allow for improved control of acid dosing by providing an adaptive control of the acid dosing cycle.

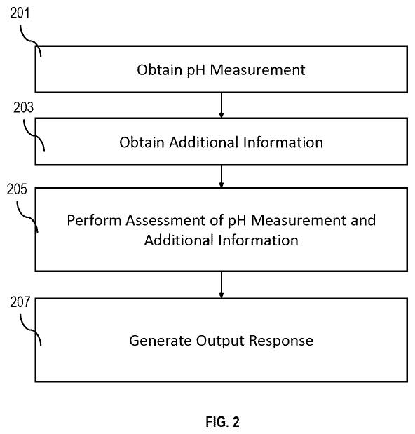

FIG. 2 illustrates an example of a method of controlling the pH of water of the pool 12 using the monitoring system 14 according to embodiments.

In a block 201, the method includes obtaining, by the control system 18, a first pH parameter. In a block 203, the method includes obtaining, by the control system 18, a second pH parameter.

The pH parameters obtained by the control system in blocks 201 and 203 may include, but are not limited to, a pH measurement, an alkalinity of the water, a volume of the swimming pool or spa, a pool or spa mode configuration, a presence and/or type of equipment impacting the pH (e.g., overflow, fountains, jets, etc.), ORP, free chlorine, total chlorine, total alkalinity, cyanuric acid, a pump filtration schedule, a water temperature, a heating mode, a historical acid dosing cycle parameter (e.g., volume, duration, etc.), combinations thereof, and/or other additional information as desired.

In certain embodiments, the first pH parameter includes one or more pH measurements from the one or more water sensing devices 16. As previously mentioned, in some embodiments, the water sensing devices 16 are reagent-based water sensing devices which automatically obtain pH measurements by utilizing liquid reagents to measure the pH of the water. As such, in some embodiments, the method includes obtaining one or more pH measurements by a reagent-based measurement. In certain embodiments, the method includes obtaining the one or more pH measurements using various communication techniques as desired between the control system 18 and the one or more water sensing devices 16.

In certain embodiments, the second pH parameter includes additional information related to the pH of the water of the pool 12. As mentioned, additional information obtained may include, but is not limited to, a volume of the pool 12, an operating configuration of the pool 12 (e.g., a pool mode, a spa mode, etc.), a presence (and/or type) of equipment impacting the pH (e.g., an overflow, a fountain, a jet, a heater, etc.), a water temperature, a filtration schedule, a water alkalinity measurement, a historical acid dosing cycle parameter (e.g., volume, duration, etc.), combinations thereof, and/or as otherwise desired.

The method may include automatically obtaining such additional information and/or passively or manually obtaining such additional information. As a non-limiting example, the method may include passively or manually obtaining the volume of the pool 12, the operating configuration of the pool 12, and/or a water alkalinity measurement from the user 38 via an application running on the user device 40 and/or via a user interface of the control system 18. As another non-limiting example, the method may include automatically obtaining the water temperature and/or the water alkalinity from one or more sensors 34 and/or automatically obtaining the operating configuration and/or filtration schedule from the equipment of the circulation system 36. Other techniques or combinations of techniques for obtaining the additional information may be utilized as desired. In one non-limiting example, the method includes obtaining at least a water alkalinity measurement as the additional information. In certain embodiments, the method includes obtaining the additional information using various communication techniques as desired.

In a block 205, the method includes performing an assessment of first pH parameter and the second pH parameter obtained in blocks 201 and 203.

In a non-limiting example, block 205 includes performing an assessment of the pH measurement (as the first pH parameter) with the additional information (as the second pH parameter). In various embodiments, by obtaining the second pH parameter (such as but not limited to the additional information) and assessing the additional information with the first pH parameter (such as but not limited to the pH measurement), the control system 18 may be able to adapt and adjust the acid dosing parameters to the particular pool system 10.

In certain embodiments, block 205 may include predicting a future pH based on the first pH parameter and the second pH parameter. In a non-limiting example, block 205 may include predicting the future pH based on the measured pH and the additional information. As non-limiting examples, block 205 may predict a change in pH based on the current pH as the first pH parameter and one or more of the volume of the pool 12, the operating mode of the pool 12, the presence of equipment with the pool 12, the water temperature, a water alkalinity value, ORP, free chlorine, total chlorine, total alkalinity, and/or cyanuric acid and/or other additional information as desired as the second pH parameter.

In some embodiments, block 205 includes comparing the measured pH to a setpoint or desired pH, and determining one or more parameters of an acid dosing cycle to reach the desired pH setpoint based on a difference between the measured pH and the setpoint and the additional information. As a non-limiting example, it may be desirable to maintain or attempt to maintain the pH of the water of the pool 12 at a setpoint between 7.2 and 7.6. In various embodiments, the one or more parameters determined in block 205 may include a volume of acid in a dosing cycle and/or a duration of dosing of acid during the dosing cycle.

As one non-limiting example, block 205 includes defining a duration and/or acid volume for an acid dosing cycle based on the current pH as the first pH parameter and the volume of the pool 12 as the second pH parameter. In this example, block 205 may include determining a first volume of acid for adjusting the pH of a pool 12 having a first volume and a second volume of acid for adjusting the pH of a pool 12 having a second volume less than the first volume to achieve a same adjustment in pH for both pools.

As a further non-limiting example, block 205 includes defining a duration of dosing of acid and/or an acid volume based on a historical or previous duration or volume of acid in an acid dosing cycle as the first pH parameter and a current difference between the measured pH and the setpoint as the second pH parameter.

As another non-limiting example, block 205 may include determining a first volume of acid for adjusting the pH of the pool 12 based on a first alkalinity measurement as the first pH parameter and a second volume of acid for adjusting the pH of the pool 12 based on a second alkalinity measurement as the second pH parameter less than the first alkalinity measurement to achieve a same adjustment in pH.

As yet another non-limiting example, block 205 may include determining a volume of acid for adjusting the pH of the pool 12 based a pH measurement as the first pH parameter and the presence of certain equipment as the second pH parameter. As anon-limiting example, block 205 may include determining a first volume of acid for adjusting the pH of the pool 12 based on the presence of an overflow, fountain, jet, and/or other equipment, and a second volume of acid for adjusting the pH of the pool 12 based on an absence of such equipment to achieve a same adjustment in pH.

The above examples are for illustrative purposes only, and other assessments based on various combinations of additional information may be implemented as desired in block 205.

In block 207, the method includes generating an output response based on the assessment of block 205.

In some embodiments, block 207 includes maintaining a status quo of the acid dosing system 20 (i.e., maintaining current parameters of the acid dosing cycle) based on the assessment of block 205 determining that a predicted pH of the water will be within a threshold or acceptable deviation of the setpoint or desired pH.

In various embodiments, block 207 includes automatically adjusting or changing the one or more parameters of the acid dosing cycle and automatically controlling the acid dosing system 20 pursuant to the adjusted parameters of the acid dosing cycle (or causing the acid dosing system to automatically perform the adjusted acid dosing cycle). As a non-limiting example, block 207 may include changing the duration of dosing and/or the acid volume based on the assessment in block 205 and controlling the acid dosing system 20 to automatically perform the acid dosing cycle with the changed duration and/or acid volume.

Optionally, block 207 includes generating an alert based on the assessment of block 205. In some embodiments, the alert may be provided to the user 38 via the user device 40, a user interface, a remote device, and/or as otherwise desired.

Various other control responses or outputs may be realized in block 207, and the aforementioned examples should not be considered limiting.

The systems and methods described herein provide improved control of pH of the water of the pool and may allow for a pool system to maintain a pH of water of the pool 12 at a setpoint and/or within a target range to minimize and/or reduce health hazards to a user and/or to minimize and/or reduce adverse effects on various equipment of the pool 12. The systems and/methods described herein provide improved acid dosing cycles accounting for both pH and the additional information which may impact the pH of the water. The systems and methods described herein may allow for improved acid dosing which is automatically adjusted based on the pH and the additional information. Various other benefits and advantages may be realized with the systems, devices, and methods provided herein, and the aforementioned advantages should not be considered limiting.

Exemplary concepts or combinations of features of the invention may include:

A. A water quality monitoring system comprising a control system configured to:
i. obtain pH measurements of water of a swimming pool or spa from a water sensing device as a first pH parameter;
ii. obtain additional information relevant to the pH of the water as a second pH parameter; and
iii. generate a control response for an automatic acid dosing system of the swimming pool or spa based on an assessment of the pH measurements with the additional information.

B. A water quality monitoring system comprising a control system configured to:
i. obtain pH measurements of water of a swimming pool or spa from a water sensing device as a first pH parameter;
ii. obtain alkalinity of the water as a second pH parameter;
iii. determine an amount and/or volume of acid based on the pH and alkalinity; and
iv. generate a control response for an automatic acid dosing system of the swimming pool or spa based on the determined amount and/or volume.

C. A water quality monitoring system configured to vary pH based on two parameters.

D. A non-transitory computer readable storage medium comprising a plurality of instructions executable by one or more processors, the plurality of instructions comprising instructions which, when executed by the one or more data processors, cause the one or more data processors to perform actions including:
i. obtaining pH measurements of water of a swimming pool or spa from a water sensing device as a first pH parameter;
ii. obtaining additional information relevant to the pH of the water as a second pH parameter; and
iii. generating a control response for an automatic acid dosing system of the swimming pool or spa based on an assessment of the pH measurements with the additional information.

E. A non-transitory computer readable storage medium comprising a plurality of instructions executable by one or more processors, the plurality of instructions comprising instructions which, when executed by the one or more data processors, cause the one or more data processors to perform actions including:
i. obtaining pH measurements of water of a swimming pool or spa from a water sensing device as a first pH parameter;
ii. obtaining alkalinity of the water as a second pH parameter;
iii. determining an amount and/or volume of acid based on the pH and alkalinity; and
iv. generating a control response for an automatic acid dosing system of the swimming pool or spa based on the determined amount and/or volume.

F. A method of monitoring a water parameter of a swimming pool or spa, the method comprising:
i. obtaining pH measurements of water of a swimming pool or spa from a water sensing device as a first pH parameter;
ii. obtaining additional information relevant to the pH of the water as a second pH parameter; and
iii. generating a control response for an automatic acid dosing system of the swimming pool or spa based on an assessment of the pH measurements with the additional information.

G. A method of monitoring a water parameter of a swimming pool or spa, the method comprising:
i. obtaining pH measurements of water of a swimming pool or spa from a water sensing device as a first pH parameter;
ii. obtaining alkalinity of the water as a second pH parameter;
iii. determining an amount and/or volume of acid based on the pH and alkalinity; and
iv. generating a control response for an automatic acid dosing system of the swimming pool or spa based on the determined amount and/or volume.

H. The system, method, or instructions of any preceding or subsequent statement or combination of statements, wherein generating the control response for the automatic acid dosing system comprises predicting an automatic acid dosing cycle for the automatic acid dosing system.

I. The system, method, or instructions of any preceding or subsequent statement or combination of statements, wherein generating the control response comprises adjusting an automatic acid dosing cycle for the automatic acid dosing system.

J. The system, method, or instructions of any preceding or subsequent statement or combination of statements, further comprising the automatic acid dosing system.

K. The system, method, or instructions of any preceding or subsequent statement or combination of statements, further comprising the water sensing device, wherein the water sensing device is configured to automatically measure the pH of the water of the swimming pool or spa.

L. The water quality monitoring system of any of preceding or subsequent statement or combination of statements, wherein the water sensing devices is a reagent-based water sensing device.

M. The system, method, or instructions of any preceding or subsequent statement or combination of statements, wherein the additional information is automatically obtained.

N. The system, method, or instructions of any preceding or subsequent statement or combination of statements, further comprising at least one sensor configured to detect the additional information and provide the additional information to the control system.

O. The system, method, or instructions of any preceding or subsequent statement or combination of statements, wherein the additional information is manually obtained or received from a user.

P. The system, method, or instructions of any preceding or subsequent statement or combination of statements, wherein the additional information comprises an alkalinity measurement.

Q. The system, method, or instructions of any preceding or subsequent statement or combination of statements, wherein the alkalinity measurement is automatically obtained from a second water sensing device.

R. The system, method, or instructions of any preceding or subsequent statement or combination of statements, wherein the additional information comprises at least one of a volume of a swimming pool or spa, an operating mode or configuration of the swimming pool or spa, a presence of equipment impacting the pH, an alkalinity measurement, a pump filtration schedule, and/or a water temperature measurement.

S. The system, method, or instructions of any preceding or subsequent statement or combination of statements, wherein generating the control response comprises defining a pH dosing cycle parameter.

T. The system, method, or instructions of any preceding or subsequent statement or combination of statements, wherein the pH dosing cycle parameter comprises a dosing duration and/or volume of acid for a dosing duration.

U. The system, method, or instructions of any preceding or subsequent statement or combination of statements, wherein generating the control response further comprises controlling the automatic acid dosing system pursuant to the predicted and/or adjusted automatic acid dosing cycle.

V. The system, method, or instructions of any preceding or subsequent statement or combination of statements, wherein the assessment comprises a comparison of an expected pH with the pH measurement.

W. The system, method, or instructions of any preceding or subsequent statement or combination of statements, wherein generating the control response comprises determining an acid dosing cycle to reach a desired pH.

X. A water quality monitoring system comprising a control system configured to: obtain a pH measurement of water of a swimming pool or spa from a water sensing device as a first pH parameter; obtain an additional information relevant to the pH of the water as a second pH parameter; determine an amount and/or volume of acid based on the first pH parameter and the second pH parameter; and generate a control response for an automatic acid dosing system of the swimming pool or spa based on the determined amount and/or volume.

Y. A non-transitory computer readable storage medium comprising a plurality of instructions executable by one or more processors, the plurality of instructions comprising instructions which, when executed by the one or more data processors, cause the one or more data processors to perform actions including: obtaining a pH measurement of water of a swimming pool or spa from a water sensing device as a first pH parameter; obtaining additional information relevant to the pH of the water as a second pH parameter as a second pH parameter; determining an amount and/or volume of acid based on the first pH parameter and the second pH parameter; and generating a control response for an automatic acid dosing system of the swimming pool or spa based on the determined amount and/or volume.

Z. A method of monitoring a water parameter of a swimming pool or spa, the method comprising: obtaining a pH measurement of water of a swimming pool or spa from a water sensing device as a first pH parameter; obtaining additional information relevant to the pH of the water as a second pH parameter as a second pH parameter; determining an amount and/or volume of acid based on the first pH parameter and the second pH parameter; and generating a control response for an automatic acid dosing system of the swimming pool or spa based on the determined amount and/or volume.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater installations. Finally, references to “pools” and “swimming pools” herein may also refer to spas or other water containing vessels used for recreation, training, or therapy.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0° or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A water quality monitoring system comprising a control system configured to:
obtain a pH measurement of water of a swimming pool or spa from a water sensing device as a first pH parameter;
obtain an additional information relevant to the pH of the water as a second pH parameter;
determine an amount and/or volume of acid based on the first pH parameter and the second pH parameter; and
generate a control response for an automatic acid dosing system of the swimming pool or spa based on the determined amount and/or volume.

2. The water quality monitoring system of claim 1, wherein the control system is configured to generate the control response for the automatic acid dosing system by predicting an automatic acid dosing cycle for the automatic acid dosing system.

3. The water quality monitoring system of claim 1, wherein the control response comprises adjusting of an automatic acid dosing cycle for the automatic acid dosing system.

4. The water quality monitoring system of claim 1, further comprising the automatic acid dosing system.

5. The water quality monitoring system of claim 1, further comprising the water sensing device, wherein the water sensing device is configured to automatically measure the pH of the water of the swimming pool or spa.

6. The water quality monitoring system of claim 5, wherein the water sensing device is a reagent-based water sensing device.

7. The water quality monitoring system of claim 1, wherein the additional information comprises at least one of a volume of a swimming pool or spa, an operating mode or configuration of the swimming pool or spa, a presence of equipment impacting the pH, an alkalinity measurement, a pump filtration schedule, and/or a water temperature measurement.

8. A non-transitory computer readable storage medium comprising a plurality of instructions executable by one or more processors, the plurality of instructions comprising instructions which, when executed by the one or more data processors, cause the one or more data processors to perform actions including:
obtaining a pH measurement of water of a swimming pool or spa from a water sensing device as a first pH parameter;
obtaining additional information relevant to the pH of the water as a second pH parameter as a second pH parameter;
determining an amount and/or volume of acid based on the first pH parameter and the second pH parameter; and
generating a control response for an automatic acid dosing system of the swimming pool or spa based on the determined amount and/or volume.

9. The non-transitory computer readable storage medium of claim 8, wherein generating the control response for the automatic acid dosing system comprises predicting an automatic acid dosing cycle for the automatic acid dosing system.

10. The non-transitory computer readable storage medium of claim 9, wherein generating the control response comprises controlling the automatic acid dosing system pursuant to the predicted acid dosing cycle.

11. The non-transitory computer readable storage medium of claim 8, wherein generating the control response comprises adjusting of an automatic acid dosing cycle for the automatic acid dosing system.

12. The non-transitory computer readable storage medium of claim 8, wherein generating the control response comprises defining a pH dosing cycle parameter.

13. The non-transitory computer readable storage medium of claim 12, wherein the pH dosing cycle parameter comprises a dosing duration and/or volume of acid for a dosing duration.

14. The non-transitory computer readable storage medium of claim 8, wherein generating the control response comprises determining an acid dosing cycle to reach a desired pH.

15. A method of monitoring a water parameter of a swimming pool or spa, the method comprising:
obtaining a pH measurement of water of a swimming pool or spa from a water sensing device as a first pH parameter;
obtaining additional information relevant to the pH of the water as a second pH parameter as a second pH parameter;
determining an amount and/or volume of acid based on the first pH parameter and the second pH parameter; and
generating a control response for an automatic acid dosing system of the swimming pool or spa based on the determined amount and/or volume.

16. The method of claim 15, wherein generating the control response for the automatic acid dosing system comprises predicting an automatic acid dosing cycle for the automatic acid dosing system.

17. The method of claim 16, wherein generating the control response comprises controlling the automatic acid dosing system pursuant to the predicted acid dosing cycle.

18. The method of claim 15, wherein generating the control response comprises adjusting of an automatic acid dosing cycle for the automatic acid dosing system.

19. The method of claim 15, wherein generating the control response comprises defining a pH dosing cycle parameter, wherein the pH dosing cycle parameter comprises a dosing duration and/or volume of acid for a dosing duration.

20. The method of claim 15, wherein generating the control response comprises determining an acid dosing cycle to reach a desired pH.
